(19) United States
(12) Patent Application Publication
(10) Pub. No.: US 2007/0299166 A1
(43) Pub. Date: Dec. 27, 2007

(54) Wood Composite Panel Containing a Bicarbonate

(75) Inventor: Eric Lawson, Hull, GA (US)

Correspondence Address: J M HUBER CORPORATION, 333 THORNALL STREET, PATENT DEPARTMENT, EDISON, NJ, 08837-2220, US

(73) Assignee: Huber Engineered Woods LLC, Charlotte, NC (US)

(21) Appl. No.: 11/426,391

(22) Filed: Jun. 26, 2006

(51) Int. Cl. B29C 47/00; C09D 5/16

(52) U.S. Cl. 524/13; 523/122

(57) ABSTRACT

Disclosed is a wood composite board comprising wood strands, a binder composition and a bicarbonate fungicide.

### BACKGROUND OF THE INVENTION

Wood can be used to construct almost any part of a home from the roofing and exterior walls to the floor and interior architectural elements as well as basic domestic items like furniture and cabinets. However, in recent years the cost of solid timber wood has increased dramatically as its supply shrinks due to the gradual depletion of old-growth and virgin forests. Indeed, it is particularly expensive to manufacture solid hardwood furniture and architectural features from such material because typically less than half of harvested timber wood is converted to natural solid wood lumber, the remainder being discarded as scrap.

Accordingly, because of both the cost of high-grade timber wood as well as a heightened emphasis on conserving natural resources, wood-based alternatives to natural solid wood lumber have been developed that make more efficient use of harvested wood and reduce the amount of wood discarded as scrap. Plywood, particle board and oriented strand board (“OSB”) are examples of wood-based composite alternatives to natural solid wood lumber that have replaced natural solid wood lumber in many structural applications in the last seventy-five years. These wood-based composites not only use the available supply of timber wood more efficiently, but they can also be formed from lower-grade wood species, and even from wood wastes.

However, like conventional solid wood lumber, these wood composite materials also suffer from unwanted wood consumers, namely fungus and microbial parasites. This is a particular problem because these wood composite products are often used indoors where the damages from parasites may be hidden and thus go unnoticed for many years getting significantly worse before eventually discovered. Particularly in an indoor setting it is very common to find leaks that form around windows and plumbing fixtures, as well as along roofs and along wall sheathing. Wood destroying fungi thrive in damp environments such as the interior portions of a wall around a leaky window, door, or plumbing fixture. Eventually these wood fixtures may be completely rotted out, before the homeowner even realizes that there is a problem.

A variety of techniques have been developed to address the issue of fungus and rot in wood composite materials. Unfortunately, most of these techniques involve compounds that are either extremely poisonous or are not suitable for use in manufacturing wood-based composites. For example, Chromated Copper Arsenic (“CCA”) has often been used in the past in manufacturing wood-based composites. However, arsenic has been known to cause cancer in humans, and this is of particular concern for two vulnerable populations: children who may put their fingers into their mouths after touching CCA-treated wood, and workers who may be exposed to airborne dust that can be ingested or inhaled, particularly after cutting CCA-treated lumber. As a consequence of the foregoing considerations the use of CCA-treated wood was completely phased out at the end of 2003.

Given the foregoing, there is a need in the art for a wood composite panel containing a fungicide that imparts a resistance to insect and fungus infestations without the use of toxic or potentially harmful chemicals.

### BRIEF SUMMARY OF THE INVENTION

The present invention relates to a wood composite board comprising wood strands, a binder composition and a bicarbonate.

The present invention also relates to a method for the production of a wood composite board comprising the steps of: providing a quantity of wood in the form of wood strands; drying the wood strands; coating the wood strands with a binder composition and a bicarbonate fungicide to from coated and treated strands; forming a mat from the coated and treated strands; pressing the mat, at a high temperature, to form the wood composite board having a final thickness.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer.

By “laminated”, it is meant material composed of layers and bonded together using resin binders.

By “wood composite material” or “wood composite component” it is meant a composite material that comprises wood and one or more other additives, such as adhesives or waxes. Non-limiting examples of wood composite materials include oriented strand board (“OSB”), structural composite lumber (“SCL”), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition, which is hereby incorporated by reference.

The present invention is directed to wood composite panels that incorporate an antimicrobial and fungicide compound (spoken collectively in the present invention as a “fungicide). The wood composite panels are made from a starting material that is naturally occurring hard or soft woods, singularly or mixed, whether such wood is dry (having a moisture content of between 2 wt % and 12 wt %) or green (having a moisture content of between 30 wt % and 200 wt %). Typically, the raw wood starting materials, either virgin or reclaimed, are cut into strands, wafers or flakes of desired size and shape, which are well known to one of ordinary skill in the art.

After the strands are cut they are dried in a drying oven (such as a tumbling oven) to a moisture content of about 2 wt % to 5 wt %. The strands are then subsequently coated with a special formulation of one or more polymeric thermosetting binder resins, waxes and other additives in a blending step. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating and treatment chemicals, these coated strands are used to form a multi-layered mat, preferably a three layered mat. This layering may be done in the following fashion. The coated flakes are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plys are surface layers, while the second ply is a core layer. The surface layers each have an exterior face.

The above example may also be done in different relative directions, so that the first ply has flakes oriented substantially perpendicular to conveyor belt, then a second ply is deposited on the first ply, with the flakes of the second ply oriented substantially parallel to the conveyor belt. Finally, a third ply having flakes oriented substantially perpendicular with the conveyor belt, similar to the first ply, is deposited on the second ply.

Various polymeric resins, preferably thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates are the preferred binders, and preferably the isocyanates are selected from the diphenylmethane-p,p′-diisocyanate group of polymers, which have NCO— functional groups that can react with other organic groups to form polymer groups such as polymrea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is Rubinate 1840 available from Huntsman, Salt Lake City, Utah, and Mondur 541 available from Bayer Corporation, North America, of Pittsburgh, Pa. Other suitable resins useful as adhesive binders either separately or in combination with pMDI are the formaldehyde-based liquid PF, powder PF, UF MUF binders, and combinations of these. Suitable commercial MUF binders are the LS 2358 and LS 2250 products from the Dynea corporation.

The binder concentration is preferably in the range of about 3 wt % to about 8 wt %. A wax additive is commonly employed to enhance the resistance of the OSB panels to moisture penetration. Preferred waxes are slack wax or an emulsion wax. The wax solids loading level is preferably in the range of about 0.1 wt % to about 3.0 wt % (based on the weight of the wood).

The bicarbonate compound may be used either in powdered form or may be dissolved in a liquid. As previously mentioned the bicarbonates are preferably applied after the drying step during the blending step (these steps are described in greater detail below, but are well-known to persons of ordinary skill in the wood composite arts). After being dried, if the bicarbonates are meant to be applied in powdered form, the powder can be added to the strands as they enter the blender with the tumbling action of the blender ensuring that the powder is evenly distributed over most or all of the strands. If meant to be applied in liquid form, the material is sprayed through a spray nozzle that evenly distributes the bicarbonates over the surface of the strands.

Other methods of application are also possible if also less preferred. For example, rather than applying bicarbonates after the drying step (as discussed above) powdered bicarbonates may be applied to the wet flakes before the drying step, further relying on the tumbling action of the dryer to distribute the powder evenly over the strands. Liquid resin could also be applied to the wet flakes. In each case, care should be taken to ensure that all surfaces of the strands are exposed to the bicarbonates.

For use in the present invention, the preferred bicarbonates are alkali or alkaline earth bicarbonates, such as calcium, potassium and sodium bicarbonate; especially preferred are potassium and sodium bicarbonate. However several other compounds are also suitable. These include transition element compounds such as copper bicarbonate, and bicarbonate salts such as ammonium bicarbonate.

The total concentration of the bicarbonates used in the present invention will be in a range of from about 0.25 wt % to about 10 wt %, such as 0.25 wt % to about 5 wt %, such as 0.25 wt % to about 1.5 wt %. One example of a suitable bicarbonate powder is baking soda (sodium bicarbonate).

After the multi-layered mats are formed according to the process discussed above, they are compressed under a hot press machine that fuses and binds together the wood materials, binder, and other additives to form consolidated OSB panels of various thickness and sizes. The high temperature also acts to cure the binder material. Preferably, the panels of the invention are pressed for 2-15 minutes at a temperature of about 175° C. to about 240° C. The resulting composite panels will have a density in the range of about 35 lbs/ft³ to about 48 lbs/ft³ I(as measured by ASTM standard D1037-98). The density ranges from 40 lbs/ft³ to 48 lbs/ft³ for southern pine, and 35 lbs lbs/ft³ to 42 lbs/ft³ for Aspen. The thickness of the OSB panels will be from about 0.6 cm (about ¼″) to about 5 cm (about 2″), such as about 1.25 cm to about 6 cm, such as about 2.8 cm to about 3.8 cm.

The invention will now be described in more detail with respect to the following, specific, non-limiting examples.

### EXAMPLES

OSB Panels having a target thickness of ¾″ and a target density of 42 pcf were prepared with Mondur G541 pMDI resin at a concentration of 5 wt % (based on the weight of the wood flakes), wax at a concentration of 2.5 wt %, and sodium or potassium bicarbonate powders added during blending at concentrations of 0.0 wt %, 0.25 wt %, 0.5 wt %, 1.5 wt %, 3 wt %, and 5.0 wt % (again based on the weight of the wood flakes) as set forth in table I and II, below.

Cubes were then cut from these panels and then tested for fungal resistance according to the test WDMA/NWWDA TM 1 test protocol. In this test, the OSB samples were exposed to the brown rot decay fungus (Gloeophyllum trabeum) and the white rot fungus (Trametes versicolor) under ideal fungal growing conditions for twelve weeks. Before testing, some of the cubes were “weathered” according to Window and Door Standard NWWDA-TM-1 (“Soil Block Test”), while others were not weathered. After exposure is completed the samples are removed and are weighed to determine the percentage of weight loss due to decay. The amount of weight loss is set forth in tables I-III, below.

TABLE I

| | | Weathered/ | | |
|---|---|---|---|---|
| | Fungicide | Non- | Fungus | Weight |
| Bicarbonate | Concentration | Weathered | Species | Loss (%) |
| Potassium | 0.0 | Non-Weathered | G. trabeum | 31.41 |
| Potassium | 0.0 | Non-Weathered | G. trabeum | 41.4 |
| Potassium | 0.0 | Non-Weathered | G. trabeum | 39.8 |
| Potassium | 0.0 | Non-Weathered | G. trabeum | 42.55 |
| Potassium | 0.25 | Non-Weathered | G. trabeum | 43.28 |
| Potassium | 0.25 | Non-Weathered | G. trabeum | 39.62 |
| Potassium | 0.5 | Non-Weathered | G. trabeum | 36.59 |
| Potassium | 0.5 | Non-Weathered | G. trabeum | 36.17 |
| Potassium | 1.5 | Non-Weathered | G. trabeum | 29.93 |
| Potassium | 1.5 | Non-Weathered | G. trabeum | 42.25 |
| Potassium | 3.0 | Non-Weathered | G. trabeum | 24.01 |
| Potassium | 3.0 | Non-Weathered | G. trabeum | 24.63 |
| Potassium | 3.0 | Non-Weathered | G. trabeum | 14.17 |
| Potassium | 5.0 | Non-Weathered | G. trabeum | 19.11 |
| Potassium | 5.0 | Non-Weathered | G. trabeum | 7.65 |
| Potassium | 0.0 | Weathered | G. trabeum | 47.17 |
| Potassium | 0.0 | Weathered | G. trabeum | 41.6 |
| Potassium | 0.0 | Weathered | G. trabeum | 41.25 |
| Potassium | 0.0 | Weathered | G. trabeum | 47.68 |
| Potassium | 0.25 | Weathered | G. trabeum | 45.44 |
| Potassium | 0.25 | Weathered | G. trabeum | 40.25 |
| Potassium | 0.5 | Weathered | G. trabeum | 36.95 |
| Potassium | 0.5 | Weathered | G. trabeum | 35.36 |
| Potassium | 1.5 | Weathered | G. trabeum | 35.77 |
| Potassium | 1.5 | Weathered | G. trabeum | 42.98 |
| Potassium | 3.0 | Weathered | G. trabeum | 37.76 |
| Potassium | 3.0 | Weathered | G. trabeum | 40.83 |
| Potassium | 5.0 | Weathered | G. trabeum | 39.66 |
| Potassium | 5.0 | Weathered | G. trabeum | 42.4 |

TABLE II

| | | Weathered/ | | |
|---|---|---|---|---|
| | Fungicide | Non- | Fungus | Weight |
| Bicarbonate | Concentration | Weathered | Species | Loss (%) |
| Potassium | 0.0 | Non-Weathered | T. versicolor | 27.32 |
| Potassium | 0.0 | Non-Weathered | T. versicolor | 24.14 |
| Potassium | 0.0 | Non-Weathered | T. versicolor | 20.55 |
| Potassium | 0.0 | Non-Weathered | T. versicolor | 22.61 |
| Potassium | 0.25 | Non-Weathered | T. versicolor | 17.48 |
| Potassium | 0.25 | Non-Weathered | T. versicolor | 20.67 |
| Potassium | 0.5 | Non-Weathered | T. versicolor | 23.79 |
| Potassium | 0.5 | Non-Weathered | T. versicolor | 22.99 |
| Potassium | 1.5 | Non-Weathered | T. versicolor | 18.71 |
| Potassium | 1.5 | Non-Weathered | T. versicolor | 18.07 |
| Potassium | 3.0 | Non-Weathered | T. versicolor | 9.82 |
| Potassium | 3.0 | Non-Weathered | T. versicolor | 13.64 |
| Potassium | 5.0 | Non-Weathered | T. versicolor | 1.72 |
| Potassium | 5.0 | Non-Weathered | T. versicolor | 1.13 |

TABLE III

| | | Weathered/ | | |
|---|---|---|---|---|
| | Fungicide | Non- | Fungus | Weight |
| Bicarbonate | Concentration | Weathered | Species | Loss (%) |
| Potassium | 0.0 | Weathered | T. versicolor | 28.34 |
| Potassium | 0.0 | Weathered | T. versicolor | 21.51 |
| Potassium | 0.0 | Weathered | T. versicolor | 24.19 |
| Potassium | 0.0 | Weathered | T. versicolor | 17.99 |
| Potassium | 0.25 | Weathered | T. versicolor | 19.68 |
| Potassium | 0.25 | Weathered | T. versicolor | 19.43 |
| Potassium | 0.5 | Weathered | T. versicolor | 24.38 |
| Potassium | 0.5 | Weathered | T. versicolor | 22.96 |
| Potassium | 1.5 | Weathered | T. versicolor | 15.12 |
| Potassium | 1.5 | Weathered | T. versicolor | 16.19 |
| Potassium | 3.0 | Weathered | T. versicolor | 17.46 |
| Potassium | 3.0 | Weathered | T. versicolor | 12.16 |
| Potassium | 3.0 | Weathered | T. versicolor | 14.74 |
| Potassium | 5.0 | Weathered | T. versicolor | 18.36 |
| Potassium | 5.0 | Weathered | T. versicolor | 12.69 |

TABLE IV

| | | Weathered/ | | |
|---|---|---|---|---|
| | Fungicide | Non- | Fungus | Weight |
| Bicarbonate | Concentration | Weathered | Species | Loss (%) |
| Sodium | 0.0 | Non-Weathered | G. trabeum | 31.41 |
| Sodium | 0.0 | Non-Weathered | G. trabeum | 41.4 |
| Sodium | 0.0 | Non-Weathered | G. trabeum | 39.8 |
| Sodium | 0.0 | Non-Weathered | G. trabeum | 42.55 |
| Sodium | 0.25 | Non-Weathered | G. trabeum | 37.55 |
| Sodium | 0.25 | Non-Weathered | G. trabeum | 47.35 |
| Sodium | 0.5 | Non-Weathered | G. trabeum | 42.63 |
| Sodium | 0.5 | Non-Weathered | G. trabeum | 47.03 |
| Sodium | 1.0 | Non-Weathered | G. trabeum | 17.86 |
| Sodium | 1.0 | Non-Weathered | G. trabeum | 22.78 |
| Sodium | 1.5 | Non-Weathered | G. trabeum | 13.95 |
| Sodium | 1.5 | Non-Weathered | G. trabeum | 14.37 |
| Sodium | 5.0 | Non-Weathered | G. trabeum | 3.02 |
| Sodium | 5.0 | Non-Weathered | G. trabeum | 3.42 |

TABLE V

| | | Weathered/ | | |
|---|---|---|---|---|
| | Fungicide | Non- | Fungus | Weight |
| Bicarbonate | Concentration | Weathered | Species | Loss (%) |
| Sodium | 0.0 | Non-Weathered | T. versicolor | 27.32 |
| Sodium | 0.0 | Non-Weathered | T. versicolor | 24.14 |
| Sodium | 0.0 | Non-Weathered | T. versicolor | 20.55 |
| Sodium | 0.0 | Non-Weathered | T. versicolor | 22.61 |
| Sodium | 0.25 | Non-Weathered | T. versicolor | 20.73 |
| Sodium | 0.25 | Non-Weathered | T. versicolor | 25.42 |
| Sodium | 0.5 | Non-Weathered | T. versicolor | 24.72 |
| Sodium | 0.5 | Non-Weathered | T. versicolor | 27.15 |
| Sodium | 1.0 | Non-Weathered | T. versicolor | 23.49 |
| Sodium | 1.0 | Non-Weathered | T. versicolor | 18.78 |
| Sodium | 1.5 | Non-Weathered | T. versicolor | 13.41 |
| Sodium | 1.5 | Non-Weathered | T. versicolor | 12.31 |
| Sodium | 5.0 | Non-Weathered | T. versicolor | 3.76 |
| Sodium | 5.0 | Non-Weathered | T. versicolor | 1.35 |

TABLE VI

| | | Weathered/ | | |
|---|---|---|---|---|
| | Fungicide | Non- | Fungus | Weight |
| Bicarbonate | Concentration | Weathered | Species | Loss (%) |
| Sodium | 0.0 | Weathered | G. trabeum | 47.17 |
| Sodium | 0.0 | Weathered | G. trabeum | 41.6 |
| Sodium | 0.0 | Weathered | G. trabeum | 41.25 |
| Sodium | 0.0 | Weathered | G. trabeum | 47.68 |
| Sodium | 0.25 | Weathered | G. trabeum | 47.07 |
| Sodium | 0.25 | Weathered | G. trabeum | 42.45 |
| Sodium | 0.25 | Weathered | G. trabeum | 40.18 |
| Sodium | 0.5 | Weathered | G. trabeum | 45.88 |
| Sodium | 0.5 | Weathered | G. trabeum | 41.27 |
| Sodium | 1.0 | Weathered | G. trabeum | 34.58 |
| Sodium | 1.0 | Weathered | G. trabeum | 41.19 |
| Sodium | 1.5 | Weathered | G. trabeum | 42.06 |
| Sodium | 1.5 | Weathered | G. trabeum | 26.18 |
| Sodium | 5.0 | Weathered | G. trabeum | 52.32 |
| Sodium | 5.0 | Weathered | G. trabeum | 22.61 |

TABLE VII

| | | Weathered/ | | |
|---|---|---|---|---|
| | Fungicide | Non- | Fungus | Weight |
| Bicarbonate | Concentration | Weathered | Species | Loss (%) |
| Sodium | 0.0 | Weathered | T. versicolor | 28.34 |
| Sodium | 0.0 | Weathered | T. versicolor | 21.51 |
| Sodium | 0.0 | Weathered | T. versicolor | 24.19 |
| Sodium | 0.0 | Weathered | T. versicolor | 17.99 |
| Sodium | 0.25 | Weathered | T. versicolor | 21.94 |
| Sodium | 0.25 | Weathered | T. versicolor | 26.16 |
| Sodium | 0.25 | Weathered | T. versicolor | 25.38 |
| Sodium | 0.5 | Weathered | T. versicolor | 20.37 |
| Sodium | 0.5 | Weathered | T. versicolor | 19.58 |
| Sodium | 1.0 | Weathered | T. versicolor | 31.6 |
| Sodium | 1.0 | Weathered | T. versicolor | 24.03 |
| Sodium | 1.5 | Weathered | T. versicolor | 16.06 |
| Sodium | 1.5 | Weathered | T. versicolor | 17.76 |
| Sodium | 5.0 | Weathered | T. versicolor | 22.46 |
| Sodium | 5.0 | Weathered | T. versicolor | 19.01 |

As can be seen in tables I-VII, the amount of wood lost to rot declined dramatically and generally in proportion to the concentration of the bicarbonate included in the wood composite panel when the wood samples were not weathered as described in the present invention. This indicates that the bicarbonate provided excellent fungicide performance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A wood composite board comprising wood strands, a binder composition and a bicarbonate fungicide, wherein the wood board is in the form of OSB.

2. The wood composite board according to claim 1, wherein the binder composition includes an isocyanate binder resin.

3. (canceled)

4. The wood composite board according to claim 1, wherein the fungicide is present in a concentration range of about 0.25 wt % to about 10 wt %.

5. The wood composite board according to claim 1, wherein the fungicide is present in a concentration range of about 0.25 wt % to about 5 wt %.

6. (canceled)

7. The panel according to claim 1, wherein the bicarbonate is an alkali bicarbonate.

8. The panel according to claim 1, wherein the bicarbonate is an alkaline earth bicarbonate.

9. The panel according to claim 1, wherein the bicarbonate is a copper bicarbonate.

10. The panel according to claim 1, wherein the bicarbonate is an ammonium bicarbonate.

11. The wood composite board according to claim 1, wherein the alkali bicarbonates are selected from the group consisting of sodium bicarbonate and potassium bicarbonate.
